(19) United States
(12) Patent Application Publication
(10) Pub. No.: US 2010/0063846 A1
(43) Pub. Date: Mar. 11, 2010

(54) System and method for storage and dissemination of personal health information

(76) Inventor: Ravi Shakamuri, Odessa, TX (US)

Correspondence Address: STRASBURGER & PRICE, LLP, 901 MAIN STREET, SUITE 4400, DALLAS, TX, 75202, US

(21) Appl. No.: 12/283,314

(22) Filed: Sep. 11, 2008

(51) Int. Cl. G06Q 50/00; G06F 17/30; G06Q 40/00

(52) U.S. Cl. 705/3; 705/7; 705/4

(57) ABSTRACT

The invention disclosed herein is a system and method for the collection and dissemination of personal health information, including demographic data, medical history and insurance coverage. The individual is issued a card containing a microchip to which information is downloaded from each healthcare provider or a central medical database. The information downloaded on the card is easily carried by the patient and provides ready access to other healthcare providers of personal health information such as past medical history, current medications, available insurance and name and address of the patient, among others. The personal health information contained on the card may be viewed by the individual and corrected if necessary.

### CROSS-REFERENCE TO RELATED APPLICATIONS

The invention disclosed herein is new matter related to an invention entitled “A Method for Online Health Management” filed on Jun. 27, 2007 and having application Ser. No. 11/823,137. Application Ser. No. 11/823,137 is hereby incorporated by reference as if fully set forth herein.

### STATEMENT REGARDING FEDERALLY SPONSORED RESEARCH AND DEVELOPMENT

The invention disclosed herein, is not the subject of federally sponsored research and development.

### BACKGROUND

1. Field

The invention disclosed herein is a system and method which enables an individual to collect, store and transport personal health information from one healthcare provider to another healthcare provider.

2. Description of Related Art

During an individual's life many healthcare providers may be consulted for the provision of routine medical care or treatment of specific illnesses, injury or other physical and mental disorders. Some of this treatment may require admission to a hospital or other in-patient treatment facility. Records are created by each healthcare provider of each interaction of an individual with the healthcare system. In many situations knowledge of the details of care and treatment provided to an individual are not available for review by current and future healthcare providers. This information may provide vital information to assist current healthcare providers in rendering quality medical and healthcare to the patient. In most situations the only way that a healthcare provider could learn of a patient's past medical history was to rely on the patient's memory or retrieve records of care and treatment possibly related to care and treatment provided to the patient long ago. A patient may remember only scant basic information regarding past care and have no memory of the details of the treatment provided. Review of past medical records to uncover significant details of the care and treatment provided depends on availability of the records. Those past records may be in the custody of another healthcare provider located in some distant geographic area. In other cases the records may have been lost or destroyed.

One solution to this problem of availability of past medical records is for each patient to keep and maintain a paper copy of their records. This solution is not practical because it assumes that a patient will be able to collect all of the paper records and keep them safely organized for review later. It also assumes that a patient will be able to carry those records to each visit with a healthcare provider. This is problematic especially if the medical records are voluminous.

Another solution to the problem of rendering medical information available to the patient and healthcare provider was disclosed by Shakamuri in application no. 11/823,137. In the aforementioned application, a system was disclosed which linked all of an individual's and family's healthcare providers together with the family by computer so that the family could monitor their health needs, seek treatment as needed and use health insurance efficiently to promote good health within the family. The information stored on a computer database would enable healthcare providers who had access to the database to retrieve personal health information for use in making recommendations regarding needed healthcare.

Recently, hospitals and institutional healthcare providers have begun keeping patient records electronically. Data and other information regarding a patient's care and treatment are entered into and maintained by a computer. This electronic medical record may be used to collect and preserve the record of the patient's visit to the hospital. However, the electronic medical record is not usually available for review to persons unconnected with the hospital or with the care provided. What is needed in the art is a readily portable method for collection of an individual's medical records throughout his/her lifetime and maintenance of the those records in a convenient form for easy transport and review by subsequent healthcare providers.

### BRIEF SUMMARY OF THE INVENTION

The invention described herein is a readily portable method for collection of an individual's personal health information throughout his/her lifetime and maintenance of those records in a convenient form for easy transport and review by subsequent healthcare providers. Specifically, the invention disclosed herein consists of a card (StarHealth Card 32) containing a microchip with sufficient memory to hold basic demographic data concerning the patient, information regarding insurance, current medical history and physical condition, past medical history, social history, current medications, and the identity of all healthcare providers among other types of information. This card could be carried by the patient in a purse or wallet and available for review by healthcare providers at any visit including emergency visits who are equipped with a device to read the information contained on the card. In this way, basic information about the patient would be conveniently and readily available for review by the healthcare providers. Past records would not have to be gathered and studied. Basic information would be available even if the patient were unconscious or otherwise unable to accurately recount his/her medical record. This instant availability of medical information would arm the healthcare provider with the basic information about the patient to begin treatment of the patient. The information stored in the card would also alert the healthcare provider to potential problems such as a drug allergy or the use of a medicine which may be contraindicated in the current health situation. Such information would promote the provision of quality healthcare and a prompt return to health by the patient. There are other advantages to use of this system of record keeping such as: (1) expediting the admission process to a hospital by having all of the relevant registration material readily available, (2) establishing a customer loyalty program for healthcare providers who use the system, (3) making the registration process at a doctor's office more convenient, and (4) providing pharmacies with pending prescriptions and a list of current medications.

### BRIEF DESCRIPTION OF THE SEVERAL VIEWS OF THE DRAWING

FIG. 1 is a diagram showing the exchange of medical information and storage of same on the StarHealth Card 32 disclosed herein.

FIG. 2 is a diagram showing first step in the exchange of medical information to a centralized data center on the StarOne data base.

FIG. 3 is a diagram showing the second step in the transfer of medical information to the StarHealth Card 32 disclosed herein.

FIG. 4 is a diagram showing the third step detailing the use of the StarHealth Card 32 disclosed herein.

### DETAILED DESCRIPTION OF THE EMBODIMENTS

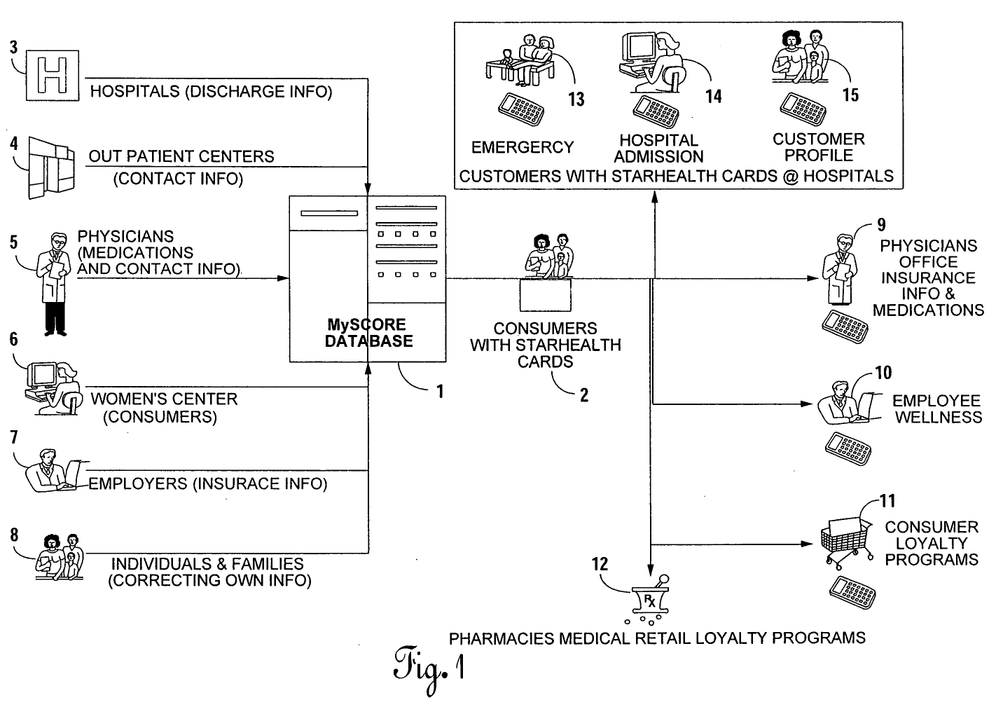

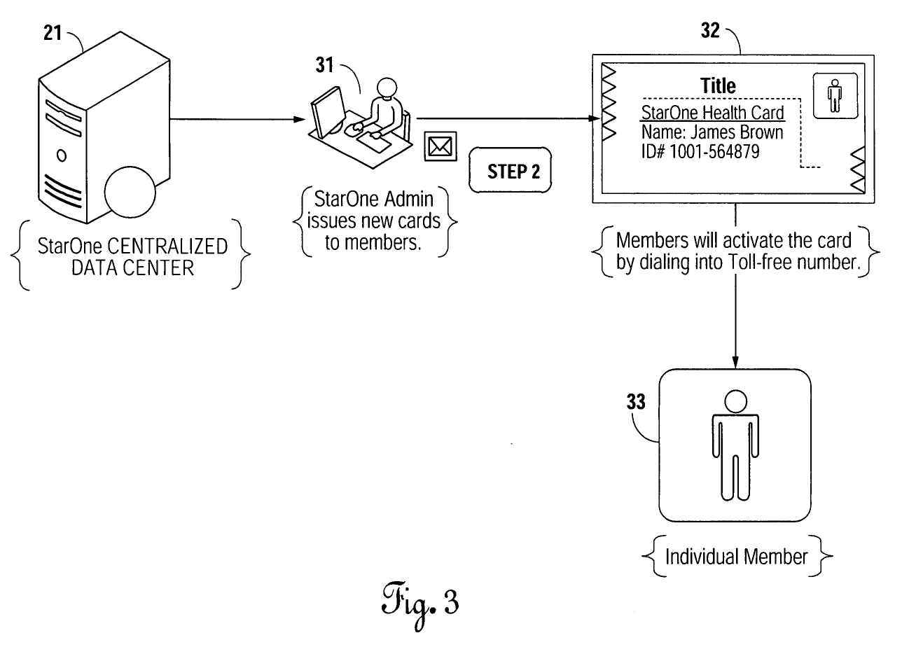

The system of personal health information collection and recording disclosed herein is an adjunct to the Online Health Management System disclosed in application U.C. No. 11/823,137. The personal health information collection and recording system disclosed herein interfaces with the aforementioned Online Health Management System and provides a convenient method for communicating vital health-related information to other healthcare providers. As shown in FIGS. 1 and 3, those consumers 2,33 who are members of the MyScore Database 1,21 of the Online Health Management System disclosed in application Ser. No. 11/823,137 receive a StarHealth Card 32 which may be issued through the Online Health Management System or participating healthcare providers. Pertinent information may be downloaded onto the StarHealth Card 32 from many different sources. For example, medical information regarding a Hospital 3 admission can be added to the StarHealth Card 32 on discharge of the patient from the Hospital 3. The MyScore Database 1 is a trademark of the StarOne centralized data center 21.

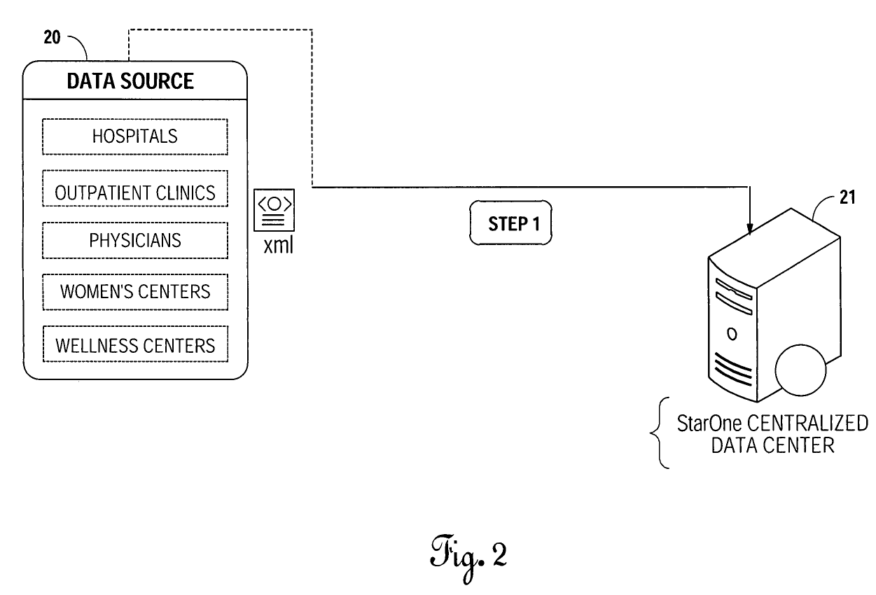

As shown in FIG. 2, the first step in issuance and usage of the StarHealth Card 32 is to receive medical information from healthcare data sources 20. The personal medical information from healthcare data sources 20 would include data from hospitals, outpatient clinics, physicians, women's centers and wellness centers. The medical information from healthcare data sources 20 is transmitted electronically to the StarOne centralized data center 1,21.

The second step in the StarOne Health management system is the preparation and issuance of a personalized StarHealth Card 32 as illustrated in FIG. 3. The medical data from healthcare data sources 20 and stored in the StarOne centralized data center 1,21, is reviewed by StarOne administration which issues a new StarHealth Card 32 specific to an individual member 2,33. The individual member 2,33 activates the member's StarHealth Card 32 by dialing a toll free number at StarOne administration 31. The StarHealth Card 32 may also be activated by other means, such as through the internet. Once activated, the StarHealth Card 32 is ready for use.

The pertinent details of Medical/Surgical treatment received at Outpatient Centers 4 may also be added to the StarHealth Card 32 as shown in FIGS. 1, 2 and 3. Medical data generated at Doctor 5 visits can be recorded on the StarHealth Card 32. Such information from the doctor would include contact information for the doctor, a description of the doctor's physical examination and a list of all treatments provided including recommendations for follow up care and any prescribed medications. The treatment and consultation received at specialty clinics such as Women's Centers 6 may also be included. Part of the information included on the StarHealth Card 32 would include identification of the patient's employer 7, any employer-funded insurance plans or other insurance coverage. Finally, the patient 8 would have access to the information contained on the StarHealth Card 32 to enable the patient 8 to view the information and make corrections if necessary. The information received from the various providers 3,4,5,6,7, or 8 could be added to the StarHealth Card 32 directly at the point of service or obtained from the individual's MyScore database 1,21. Medical data generated from the doctor's office visit includes medications prescribed at the doctor's office or at any of the medical facilities. Healthcare providers including physicians will have the provision to prescribe medications directly onto the card through the computer work station at the facility. Medications prescribed on the card are stored in the database 1 in addition to transmitting the prescribed medications to the pharmacy preferred by the consumer in an electronic format. This process will establish a current medications listing on the database 1,21 and on the StarHealth Card 32 and one-source location for the pharmacies and patients to keep track of individual consumer medication profile.

Referrals amongst the medical providers are initiated either on paper or by a phone call between the medical providers. StarHealth Card 32 will facilitate a service by which medical facilities and providers will have the capability to enter the referral to the next medical provider and/or facility on the StarHealth Card 32. Referral information on the card is picked up by the database 1,21 and informs the consumer's designated health watcher about the referral, and also informs the healthcare facility and/or medical provider to whom the referral is made about the time, date, consumer name and referring medical provider information in an electronic format.

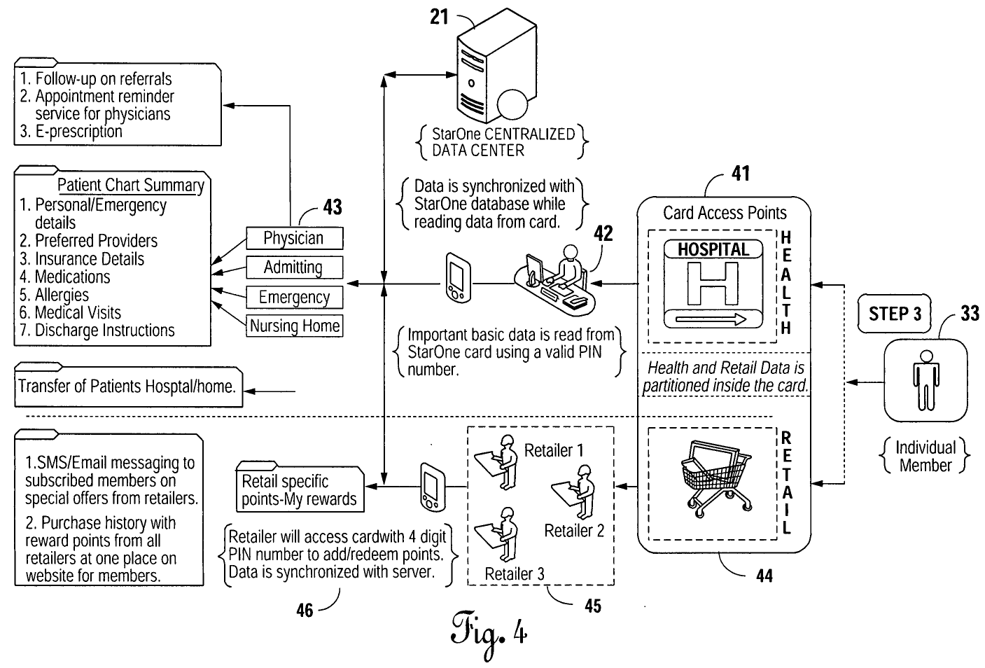

The details (Step 3) of a member's 2,33 use of the StarHealth Card 32 are shown in FIG. 4. When a member seeks medical attention at a hospital 41, for example, the hospital 41 is equipped with a reader 42 to extract the relevant information from the StarHealth Card 32. The information on the StarHealth Card 32 is synchronized to the StarOne centralized data center 21. The data on the StarHealth Card 32 is passed on to the member's 2,33 healthcare team 43 such as physicians, admitting personnel, emergency department staff and nursing home personnel who may view the health information stored on the StarHealth Card 32. The information contained on the StarHealth Card 32 would include such items as personal details, identity of preferred health providers, details regarding applicable health insurance, current medications, current allergies, details of recent doctor visits, and discharge instructions. This information can be used by the healthcare team 43 to schedule follow up appointments with physicians, develop additional plans of care and electronically prescribe medications.

The information contained on the StarHealth Card 32 could be used in a variety of ways. Again, as shown in FIGS. 1 and 3, when a consumer 2,33 with a StarHealth Card 32 seeks treatment at a physician's office 9, the demographic information including identification of insurance and other personal data is readily available to the physician's staff office. 9. In addition, the staff of the physician's office 9 would have ready access to pertinent health information including recent hospital admissions, treatment at outpatient facilities, current medications and medical history.

In another embodiment of the invention disclosed herein, the personal health information stored on the StarHealth Card 32 could be used by employee wellness programs 10. Basic health information could be stored and tracked to evaluate the effectiveness of the employee wellness program 10. By making readily available such information as height, weight, blood pressure, basic blood chemistry values and other health information would assist the wellness program in devising a plan to promote an individual's health. It would provide the information to enable the wellness program staff to measure the efficiency of the individual's health program and make changes as necessary.

In another embodiment, as shown in FIG. 4, the StarHealth Card 32 may be used to make retail purchases. The individual member 2,33 makes retail purchases 44 from a variety of participating retailers 45. The participating retailers 45 add points for purchases to an individual member's 2,33 StarHealth Card 32. These points may be used by the individual member 2,33 to pay for items selected from participating retailers 45. The participating retailers 45 can also deduct points from the individual member's 2,33 StarHealth Card 32 to pay for retail purchases. The transactions involving the addition or subtraction of points from a StarHealth Card 32 are recorded in the StarOne centralized data center 21.

In another embodiment of the invention disclosed herein, use of the personal health information could generate discounts on the purchase of consumer items, pharmaceutical and medical products through consumer loyalty programs 11 and Pharmacy/Medical Retail Loyalty programs 12. Retailers who are participants in the StarHealth Card 32 system could offer discounts to participants 2,33 and encourage them to be repeat customers of services. Savings garnered through expedited registration and convenient access to the necessary information could be used to fund such customer loyalty programs 11, 12. StarHealth Card 32 is designed to subscribe up to 900 retailers 45 in each market area to provide discounts on their services. Consumers having StarHealth Card 32 will have access to all the retailers 45 “Accepting StarHealth Card” in their retail facilities, will receive “discounts” on the retail products and services offered by the retailers in addition to having an option to accrue points which the consumers can avail to receive products from a web site by redeeming the points garnered from all the participating retailers 45.

When admission to a hospital 13 is required, the necessary information such as demographic and insurance availability would be readily available on the StarHealth Card 32 and facilitate admission to the hospital. No more would there be confusion or uncertainty as to the availability of insurance. Moreover, on admission to a hospital 13, the patient's medical history, recent medications and other vital health information would be readily available to the healthcare providers. Such information would be available whether or not the patient with a StarHealth Card 32 was unconscious or unable to provide information regarding personal health information to the healthcare providers. Expediting the check-in process at the hospital, Emergency Room or at the Physician office is facilitated under the “Star Express Check-in” system that identifies key information elements required at each one of these points of care specific to that healthcare facility and/or provider. Healthcare providers will have easier access to critical information including Living Will, Religious Preferences and Medical Power of Attorney documentation available on web site connected to the health card. In this way, the healthcare providers could make more accurate decisions about the type and extent of healthcare needed by the patient with the StarHealth Card 32.

In another embodiment, hospitals and other healthcare providers could establish a profile of the patient/customers who utilize their services and facilities 15. The information obtained from consumers 2, 33 with StarHealth Cards 32 would enable hospitals to know who their patients were, the geographic locale from which the patient came and the reason that they used the services/facilities. This information would enable the hospital 13 to tailor its services to their customers and concentrate on those facilities and services in greatest demand. Establishing personal preferences at the point of care in a healthcare facility is facilitated under the “Star Personal Preferences” system identifying the consumer's special needs and personal preferences related to that facility including diet requirements, staff preferences, room & board preferences.

In addition to the personal preference documented on the card, StarHealth Card 32 will have an option to customize the design of the card specific to children, teens, adults and seniors to upload their favorite pictures to the StarHealth Card 32 enrollment service to print these pictures on top of the StarHealth Card 32 to deliver the “Star Custom Option” for each consumer in order to customize the card also to individual preferences.

In another embodiment, the StarHealth Card 32 with detailed insurance benefits coverage information provides an opportunity for the consumer to maximize benefits utilization. This provision also helps healthcare providers including physicians, hospitals and other service providers having access to reliable insurance coverage, benefits and reimbursement when patients visit their facilities.

StarHealth Card 32 will have agreements with insurance companies to synchronize benefits utilization including deductibles, current paid out deductible, authorized services and covered providers. This provision eliminates “benefits verification” at all points of contact between patient and providers.

StarHealth Card 32 emphasizes wellness services including utilization of the “wellness benefit” available in every individual insurance coverage. StarHealth Card 32 has a system by which the “wellness benefit” is scheduled into a database 1,21, and at the appropriate time and date, covered beneficiary or authorized member is reminded by SMS/Text messaging to utilize the wellness benefit, such as annual physical exam, eye exam, dental exam, and age and gender specific wellness visits that are covered under that individual specific insurance program.

StarHealth Card 32 will also connect retailers and professionals in the community offering services targeting wellness, such as weight loss centers, gyms, dieticians to provide direction to the consumer as well as for the service providers to support each other.

In another embodiment, the StarHealth Card 32 issued to students in a school setting will allow to (a) provide the school nurse with accurate information about student's allergies, medications, medical history and primary physician details, (b) connect the school nurse visit information to the primary care provider and (c) connects the school wellness program vital sign information to the primary care physician. In the wellness tracking for students at school, StarHealth Card 32 will also track the type of exercises done by the students in their Physical Education class, in addition to the nutrition class schedule, with online access to the curriculum on the StarHealth Card 32 web site.

The system and method of the invention disclosed herein is composed of many different embodiments not specifically disclosed. These other embodiments are included in this application within the scope and meaning of the appended claims.

I claim:

1. A method for the collection, storage and transport of data by way of a computer readable card comprising steps of:
sending data to the computer readable card;
storing data on said computer readable card;
transporting said with said computer readable card;
retrieving data from the computer readable card.
Whereby data is transferred from one computer database to another computer database by way of a computer readable card.

2. The method as defined in claim 1 wherein said data is personal health information.

3. The method as defined in claim 1 wherein said computer readable card is a small plastic card into which a computer chip containing computer memory is embedded.

4. The method as defined in claim 1 wherein said data is information regarding available health insurance.

5. The method as defined in claim 1 wherein said data is demographic information of a patient.

6. A system for the collection, storage and transport of data comprising a small plastic card into which a computer chip containing computer memory is embedded.

7. The system as defined in claim 6 wherein said data is personal health information.

8. The system as defined in claim 6 wherein said data is information regarding available health insurance.

9. The system as defined in claim 6 wherein said data is demographic information of a patient.

10. A method for personal health information management comprising steps of:
entering personal health information into a computer database;
transferring said personal health information to a portable computer readable card;
sending said personal health information on said portable computer readable card to another computer database;
reading said personal health information on said another computer database;
whereby said personal health information is transferred to and from healthcare providers by way of a readily transportable computer readable card so as to facilitate the provision of healthcare to the patient.

11. A method for personal health information management comprising steps of:
entering personal health information into a computer database;
transferring said personal health information to a central computer database;
sending said personal health information on said central computer database to a readily portable computer readable card;
transmitting said personal health information on said readily portable computer readable card to another computer database;
whereby the said personal health information is transferred from one healthcare provider to a central database where said personal health information is then transferred to a readily transportable computer readable card which in turn transmits the health information contained on the computer readable card to another computer database for review and evaluation by another healthcare provider.

12. A system for personal health information management comprising:
entry of personal health information into a computer database;
transfer of said personal health information to a readily transportable computer readable card;
transfer of said personal health information contained within said readily transportable computer readable card to another computer database:
review of said personal health information contained on said another computer database for effective management of the patients healthcare needs.

13. A system for personal health information management comprising:
entry of health information into a computer database;
transfer of said personal health information to a central computer database;
sending said personal health information contained in said central computer database to a readily transportable computer readable card;
transfer of said personal health information from said readily transportable computer readable card to another computer database;
review of said personal health information contained in said another computer database by a healthcare provider for effective management of the patient's healthcare needs.
